(19) United States
(12) Patent Application Publication
(10) Pub. No.: US 2018/0320493 A1
(43) Pub. Date: Nov. 8, 2018

(54) AUTOMATED UPSCALING OF RELATIVE PERMEABILITY USING FRACTIONAL FLOW IN SYSTEMS COMPRISING DISPARATE ROCK TYPES

(71) Applicant: LANDMARK GRAPHICS CORPORATION, Houston, TX (US)

(72) Inventors: Travis St. George RAMSAY, Hockley, TX (US); Timothy Jeremiah KHO, Houston, TX (US)

(73) Assignee: LANDMARK GRAPHICS CORPORATION, Houston, TX (US)

(21) Appl. No.: 15/770,707

(22) PCT Filed: Dec. 1, 2015
(86) PCT No.: PCT/US2015/063241

§ 371 Date: Apr. 24, 2018

(51) Int. Cl. E21B 43/17; E21B 43/26; G06G 7/48

(52) U.S. Cl. CPC E21B 43/17; G06G 7/48; E21B 43/26

(57) ABSTRACT

Systems and methods for automated upscaling of relative permeability using fractional flow in systems comprising disparate rock types after actual convergence of a production rate and an injection rate using a three-dimensional (3D) reservoir simulator.

### FIELD OF THE DISCLOSURE

The present disclosure generally relates to systems and methods for automated upscaling of relative permeability using fractional flow in systems comprising disparate rock types. More particularly, the present disclosure relates to automated upscaling of relative permeability using fractional flow in systems comprising disparate rock types after actual convergence of a production rate and an injection rate using a three-dimensional (3D) reservoir simulator.

### BACKGROUND

The identification of rock types, also referred to as petrofacies or electrofacies, as a method of reservoir characterization is indispensable for accurate prediction of hydrocarbon production from subsurface reservoirs. Identifying petrofacies or electrofacies is an essential process for up-scaling, which is a part of the combined reservoir characterization and predictive analysis (simulation) process. Upscaling refers to the process of assigning petrophysical and hydraulic conductivity properties determined from smaller scale measurements to a larger scale, which would typically be used to describe subsurface rock types in the grid-cells of a reservoir simulation model. The petrofacies or electrofacies are used in conjunction with the disparate petrophysical and/or hydraulic properties to spatially characterize multiphase (fractional) fluid flow behavior in the cells of the 3D geocellular grid. Conventional upscaling techniques condition upscaling on an estimated time to convergence of the production rate and the injection rate as opposed to an actual convergence of the production rate and the injection rate. Consequently, conventional upscaling must be re-executed (simulated) for a much longer duration or an inaccurate (i.e. divergent) upscaling solution might be computed. Thus, conventional upscaling of relative permeability either leads to inaccurate solutions or solutions that take too long to compute because the simulation time is based on trial and error and/or continuous observations followed by updates.

### BRIEF DESCRIPTION OF THE DRAWINGS

The present disclosure is described below with references to the accompanying drawings in which like elements are referenced with like reference numerals, and in which:

FIGS. 1A-1B are a flow diagram illustrating one embodiment of a method for implementing the present disclosure.

FIG. 2. is a an exemplary two dimensional line plot illustrating oil and water production rates as a function of cumulative time for step 114 in FIG. 1A.

FIG. 3. is an exemplary cross-plot illustrating oil saturation and upscaled relative permeability computed according to the method in FIGS. 1A-1B.

FIG. 4. is an exemplary cross-plot illustrating a comparison of upscaled relative permeability computed using the method in FIGS. 1A-1B and conventional upscaling.

FIG. 5 is a block diagram illustrating one embodiment of a computer system for implementing the present disclosure.

### DETAILED DESCRIPTION OF THE PREFERRED EMBODIMENTS

The present disclosure overcomes one or more deficiencies in the prior art by providing systems and methods for automated upscaling of relative permeability using fractional flow in systems comprising disparate rock types after actual convergence of a production rate and an injection rate using a three-dimensional (3D) reservoir simulator.

In one embodiment, the present disclosure includes a method for upscaling relative permeability using fractional flow in systems comprising disparate rock types, which comprises: a) initializing a pressure buildup stage for an initialized numerical model by running the reservoir simulator for a time increment (i) corresponding to a predetermined pressure buildup time step used to run the reservoir simulator on the initialized numerical model; and ii) bounded by a maximum fluid flow rate; b) initializing a fractional fluid flow stage for a last numerical model run by running the reservoir simulator for a time increment corresponding to a predetermined fractional fluid flow time step to produce an actual production rate based on an actual injection rate; c) repeating step b) for each next fractional fluid flow stage; d) computing an upscaled absolute permeability for a system comprising disparate rock types using a computer processor and a predetermined fractional fluid flow time step for an actual production rate and an actual injection rate that have converged to within a predetermined tolerance for the fractional fluid flow stage; and e) computing an upscaled relative permeability for the system by dividing an upscaled effective permeability by the upscaled absolute permeability computed in step d).

In another embodiment, the present disclosure includes a non-transitory program carrier device tangibly carrying computer executable instructions for upscaling relative permeability using fractional flow in systems comprising disparate rock types, the instructions being executable to implement: a) initializing a pressure buildup stage for an initialized numerical model by running the reservoir simulator for a time increment (i) corresponding to a predetermined pressure buildup time step used to run the reservoir simulator on the initialized numerical model; and ii) bounded by a maximum fluid flow rate; b) initializing a fractional fluid flow stage for a last numerical model run by running the reservoir simulator for a time increment corresponding to a predetermined fractional fluid flow time step to produce an actual production rate based on an actual injection rate; c) repeating step b) for each next fractional fluid flow stage; d) computing an upscaled absolute permeability for a system comprising disparate rock types using a predetermined fractional fluid flow time step for an actual production rate and an actual injection rate that have converged to within a predetermined tolerance for the fractional fluid flow stage; and e) computing an upscaled relative permeability for the system by dividing an upscaled effective permeability by the upscaled absolute permeability computed in step d).

In yet another embodiment, the present disclosure includes a non-transitory program carrier device tangibly carrying computer executable instructions for upscaling relative permeability using fractional flow in systems comprising disparate rock types, the instructions being executable to implement: a) initializing a pressure buildup stage for an initialized numerical model by running the reservoir simulator for a time increment (i) corresponding to a predetermined pressure buildup time step used to run the reservoir simulator on the initialized numerical model; and ii) bounded by a maximum fluid flow rate; b) initializing a fractional fluid flow stage for a last numerical model run by running the reservoir simulator for a time increment corresponding to a predetermined fractional fluid flow time step; c) repeating step b) for each next fractional fluid flow stage; d) computing an upscaled absolute permeability for a system comprising disparate rock types using a predetermined fractional fluid flow time step for an actual production rate and an actual injection rate that have converged to within a predetermined tolerance for the fractional fluid flow stage; e) computing an upscaled relative permeability for the system by dividing an upscaled effective permeability by the upscaled absolute permeability computed in step d); f) running the reservoir simulator on the numerical model used in step a) for another predetermined pressure buildup time step; and g) repeating step f) until the another predetermined pressure buildup time step is greater than a predetermined pressure buildup time control.

The subject matter of the present disclosure is described with specificity; however, the description itself is not intended to limit the scope of the disclosure. The subject matter thus, might also be embodied in other ways, to include different structures, steps and/or combinations similar to and/or fewer than those described herein in conjunction with other present or future technologies. Moreover, although the term “step” may be used herein to describe different elements of methods employed, the term should not be interpreted as implying any particular order among or between various steps herein disclosed unless otherwise expressly limited by the description to a particular order. While the present disclosure may be applied in the oil and gas industry, it is not limited thereto and may also be applied in other industries to achieve similar results.

### Method Description

The following description includes automated methods for upscaling relative permeability using fractional fluid flow in systems comprising disparate rock types after actual convergence of a production rate and an injection rate using a three-dimensional (3D) reservoir simulator. The fractional flow of a liquid component is the ratio of its rate of injection or production to the total injection or production rate for a two component fluid flow. By definition, the value of fractional fluid flow is between 0 and 1. Thus, the fractional fluid flow stages coincide with each real number fractional value between 0 and 1 that describes the corresponding injection/production flow rate. The fractional flow for the first fluid component is computed as fᵢ in the closed interval 0 to 1; while the fractional flow of the second fluid components is 1-fᵢ in the corresponding closed interval 1 to 0. The flow rate for each fluid component is computed as the maximum flow rate multiplied by the fractional flow at a given fractional flow stage.

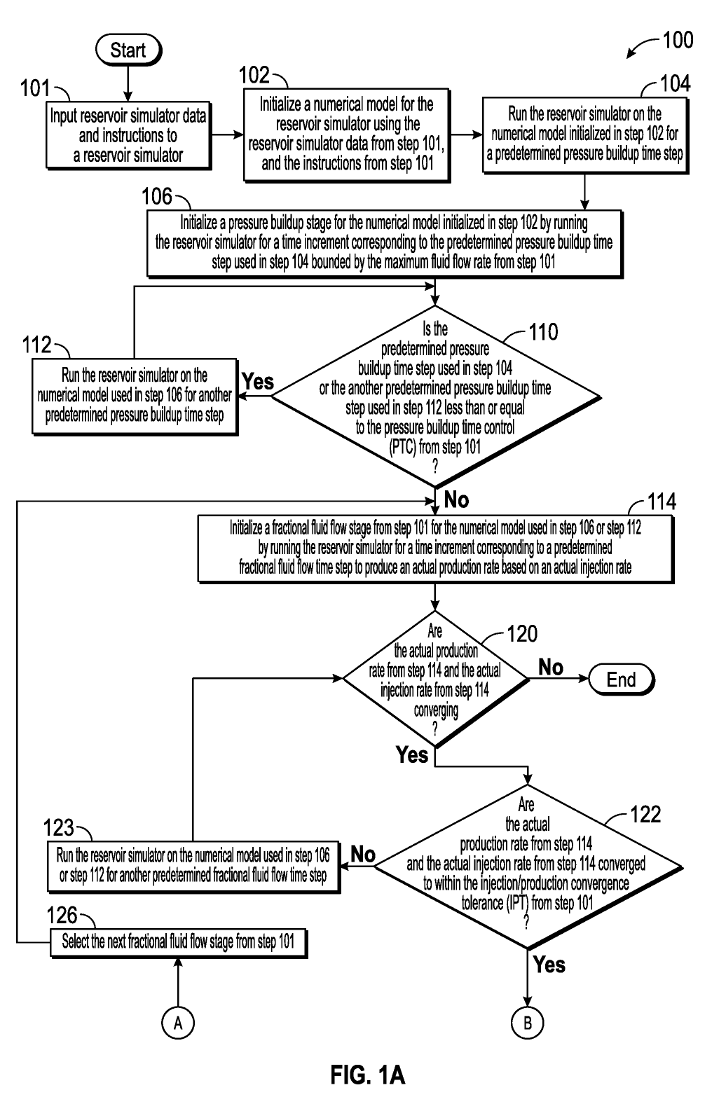

Referring now to FIGS. 1A-1B, a flow diagram of one embodiment of a method 100 for implementing the present disclosure is illustrated. The method 100 illustrates the effect of stratification on fractional fluid flow in permeable rock types in order to differentiate fluid effect from the effect of pore space geometry/distribution. The method 100 not only updates the volumetric rate of fluid injected but it does so based on the outflow of previously injected fluid during the course of the relative permeability upscaling by fractional flow.

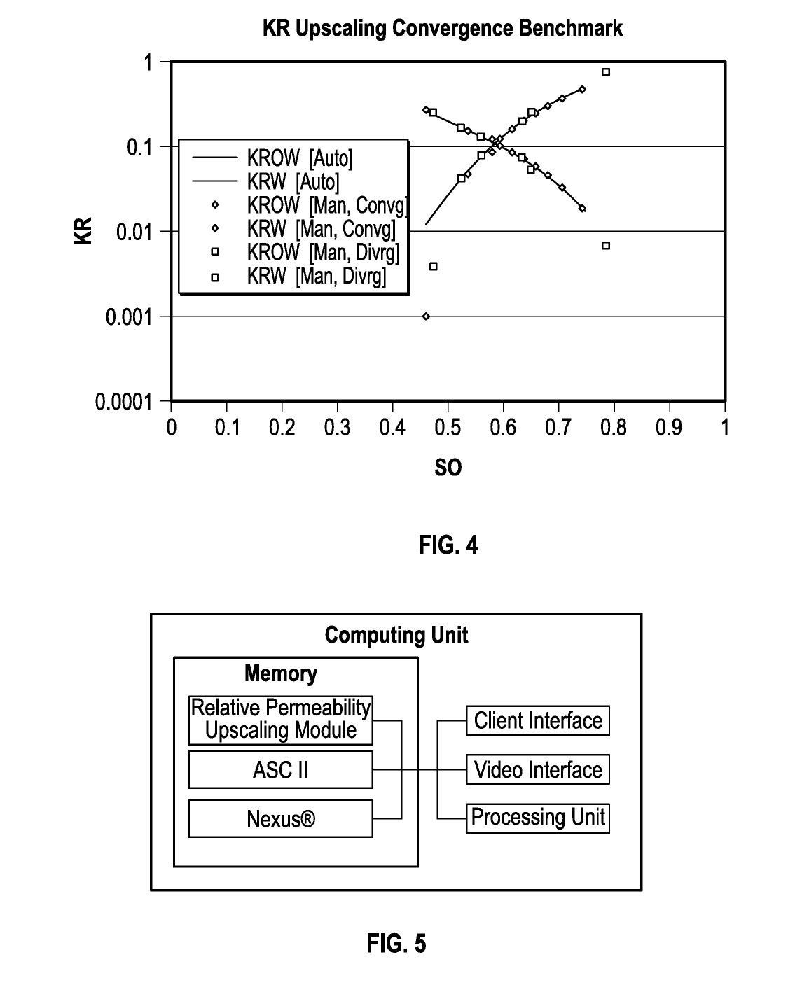

In step 101, reservoir simulator data and instructions are automatically input to a reservoir simulator or may be input using the client interface and/or the video interface described further in reference to FIG. 5. The reservoir simulator data may be derived from a combination of seismic and log petrophysical data retrieved from sensors and/or determined by techniques well-known in the art. The reservoir simulator data includes data related to a system comprising disparate rock types such as, for example: porosity, absolute permeability, relative permeability, capillary pressure (if available), petrophysical cutoffs, maximum fluid flow rate, number of fractional fluid flow stages (FS), pressure buildup time control (PTC) and injection/production convergence tolerance (IPT). Capillary pressure should be included, if available, as a simulation condition for capillary limit upscaling. Otherwise the method 100 is performed by viscous limit upscaling.

In step 102, a numerical model is initialized for the reservoir simulator using the reservoir simulator data from step 101, the instructions from step 101 and techniques well known in the art. The numerical model is a model of the system comprising disparate rock types to be modeled by the reservoir simulator, which may be dynamically advanced in time by step 104. The relative permeability and available capillary pressure from step 101 are assigned to a geocellular grid for the numerical model based on the petrophysical cutoffs from step 101.

In step 104, the reservoir simulator is run on the numerical model initialized in step 102 for a predetermined pressure buildup time step using techniques well known in the art.

In step 106, a pressure buildup stage is initialized for the numerical model initialized in step 102 by using techniques well known in the art to run the reservoir simulator for a time increment corresponding to the predetermined pressure buildup time step used in step 104 bounded by the maximum fluid flow rate from step 101. In this manner, the fluid flow rate is gradually increased thus, increasing the pressure buildup in the numerical model used in step 104 while maintaining a smooth pressure buildup solution.

In step 110, the method 100 determines if the predetermined pressure buildup time step used in step 104 or the another predetermined pressure buildup time step used in step 112 is less than or equal to the pressure buildup time control (PTC) from step 101. The predetermined pressure buildup time step from step 104 is used for the first iteration of this step and the another predetermined pressure buildup time step from step 112 is used for all subsequent iterations. If the predetermined pressure buildup time step used in step 104 or the another predetermined pressure buildup time step used in step 112 is not less than or equal to the PTC from step 101, then the method 100 proceeds to step 114. Otherwise, the method 100 proceeds to step 112.

In step 112, the reservoir simulator is run on the numerical model used in step 106 for another predetermined pressure buildup time step using techniques well known in the art. The another predetermined pressure buildup time step is returned to step 110.

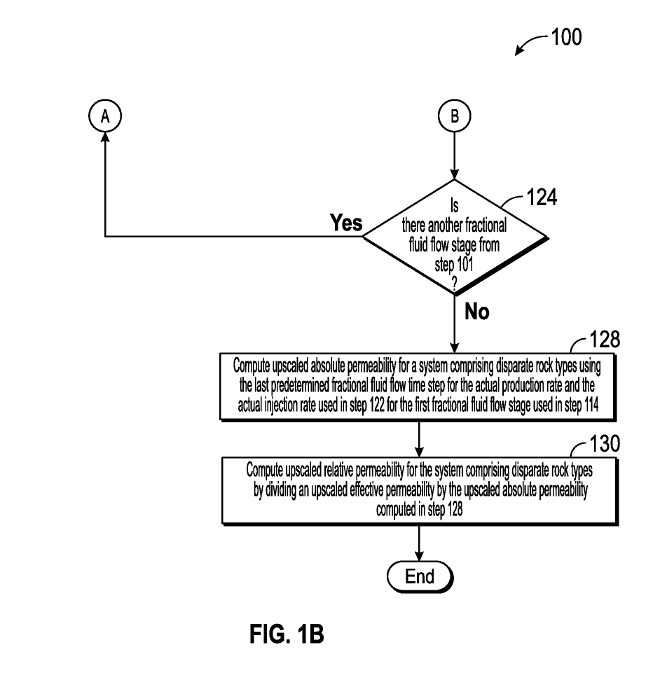

In step 114, a fractional fluid flow stage from step 101 is initialized for the numerical model used in step 106 or step 112 by using techniques well known in the art to run the reservoir simulator for a time increment corresponding to a predetermined fractional fluid flow time step and produce an actual production rate based on an actual injection rate. The actual injection rate is defined as the maximum fluid flow rate from step 101 multiplied by the fractional fluid flow for the respective stage of the computation. As an example, the fractional fluid flow in FIG. 2 at the sixth fractional flow stage occurring at 400 hours corresponds to a fractional flow rate of water of 82% of the maximum fluid flow rate and a fractional fluid flow rate of oil of 18%. The actual injection rate and the actual production rate from this step are thus, different for each fractional fluid flow stage from step 101 that is initialized.

In step 120, the method 100 determines if the actual production rate from step 114 and the actual injection rate from step 114 are converging. If the actual production rate from step 114 and the actual injection rate from step 114 are not converging, then the method 100 ends. Otherwise, the method 100 proceeds to step 122.

In step 122, the method 100 determines if the actual production rate from step 114 and the actual injection rate from step 114 are converged to within the injection/production convergence tolerance (IPT) from step 101. If the actual production rate from step 114 and the actual injection rate from step 114 are not converged to within the IPT from step 101, then the method 100 proceeds to step 123. Otherwise, the method 100 proceeds to step 124.

In step 123, the reservoir simulator is run on the numerical model used in step 106 or step 112 for another predetermined fractional fluid flow time step using techniques well known in the art. The another predetermined fractional fluid flow time step is returned to step 120. Because the reservoir simulator is advanced to another predetermined fractional fluid flow time step, the actual production rate will change, however, the actual injection rate and the fractional fluid flow stage from step 114 are maintained.

In step 124, the method 100 determines if there is another fractional fluid flow stage from step 101. If there is not another fractional fluid flow stage from step 101, then the method 100 proceeds to step 128. Otherwise, the method 100 proceeds to step 126.

In step 126, the next fractional fluid flow stage from step 101 is selected and returned to step 114. This is illustrated in FIG. 2 as a decrease in the rate of production, and thus injection, of water at a cumulative time of 500 hours from the 82% fractional fluid flow stage to the 79% fractional fluid flow stage. As a corollary, the rate of production, and thus injection, of oil increases from 18% fractional fluid flow stage to the 21% fractional fluid flow stage at the same time interval.

In step 128, upscaled absolute permeability for a system comprising disparate rock types is computed using the last predetermined fractional fluid flow time step for the actual production rate and the actual injection rate used in step 122 for the first fractional fluid flow stage used in step 114. The upscaled absolute permeability may be computed according to Darcy's Law, which expresses permeability as:

$${K}_{Abs} = \frac{q μ}{A ∇ P} \qquad ( 1 )$$

wherein (K_{Abs}) is the upscaled absolute permeability, (q) is the average of the actual production rate and the actual injection rate of the single fluid component in this first fractional fluid flow stage, (μ) is the viscosity of the fluid component and (∇P) is the pressure gradient applied to the system.

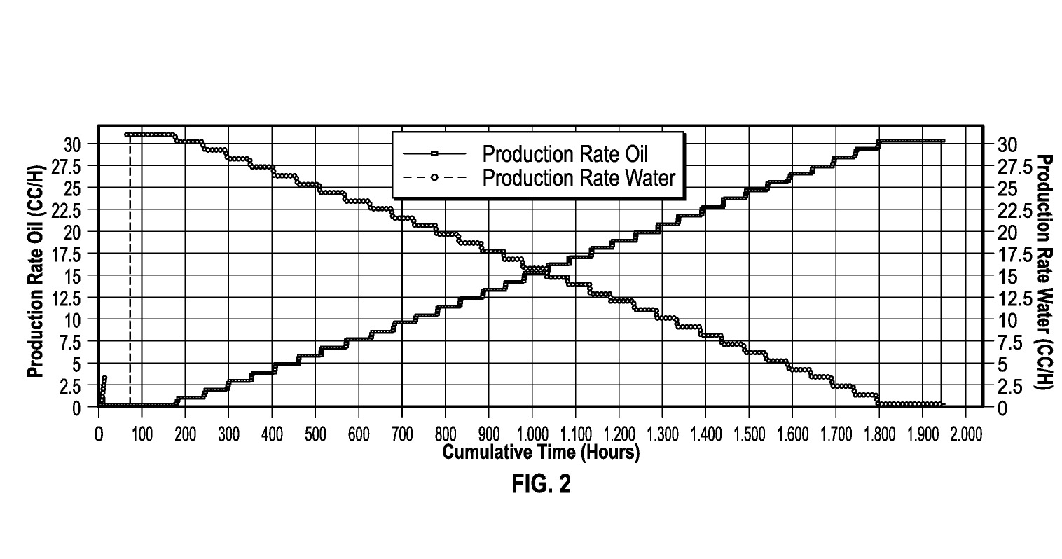

In step 130, upscaled relative permeability for the system comprising disparate rock types is computed by dividing an upscaled effective permeability by the upscaled absolute permeability computed in step 128. Upscaled effective permeability is determined using equation (1), but is computed in the presence of a second fluid component. Here, (q) and (μ) are expressed for the specific fluid component. The upscaled relative permeability is thus, computed according to:

$${K}_{r , i} = \frac{{K}_{eff , i}}{{K}_{Abs}} \qquad ( 2 )$$

wherein (K_{r,i}) is the relative permeability with respect to the i^{th} fluid component, (K_{eff,i}) is the effective permeability for the i^{th} fluid component and (K_{Abs}) is the upscaled absolute permeability computed in step 128. In the example illustrated in FIG. 3 the system includes two disparate rock types: i) rock type 1 having an exemplary absolute permeability of 100 mD and relative permeability characterized by KRW IN 1 and KROW IN 1; and ii) rock type 2 having an exemplary absolute permeability of 10 mD and relative permeability characterized by KRW IN 2 and KROW IN 2. The two rock type system is upscaled using method 100 to yield the upscaled relative permeability described by KRW OUT and KROW OUT.

The method 100 does not require trial and error or continuous monitoring and feedback like conventional techniques. Due to the convergence analysis of injection and production conditions, relative permeability can be upscaled by the method 100 in a shorter period of time because i) achieved convergence initiates the execution of an updated fractional flow instead of continuous monitoring and feedback upon the completion of previous fractional flow stage; and ii) spurious upscaled solutions can be terminated without interaction with the reservoir simulator. In the coreflooding process, method 100 is more accurate because it follows the exact fractional flow process of two component fluid upscaling, which takes place in a physical laboratory. The results of the method 100 thus, can be used to validate composite core flooding performed by physical laboratories.

### Example

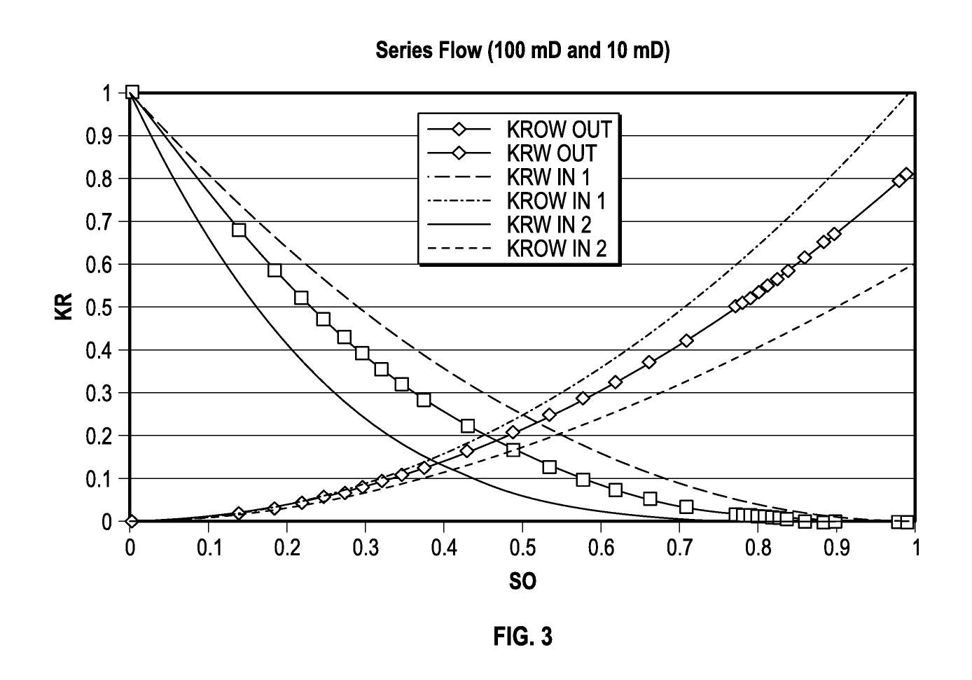

In table 1 below, synthetic (simulated) data was used to compare computations of upscaled relative permeability and upscaled absolute permeability, and their respective run time on a reservoir simulator, using i) the upscaling method 100 (automated process with a convergence analysis); and ii) conventional upscaling (manual submission). In each, computations were performed as a serial process on 1 core of HP Z800 24 GB memory. As demonstrated by the results in table 1, conventional upscaling takes longer to compute because it requires an estimation of run time to establish convergence before the run is executed. Diverged results were executed over 250 time steps while converged results were executed over 2500 time steps. Because relative permeability yields multiple computations, one corresponding to each respective fractional fluid flow stage the comparison of upscaled relative permeability is illustrated in FIG. 4.

TABLE 1

| | Automated Process with | | Manual Submission | | | |
|---|---|---|---|---|---|---|
| | Convergence Analysis | | Diverged | | Converged | |
| | | Computed | | Computed | | Computed |
| | Run Time | Permeability | Run Time | Permeability | Run Time | Permeability |
| | (hr:min:sec) | (mD) | (hr:min:sec) | (mD) | (hr:min:sec) | (mD) |
| A (relative permeability) | 01:52:26 | * | <02:54:50 | * | 02:54:50 | * |
| B (absolute permeability) | 00:11:04 | 8.91 mD | 00:01:31 | 8.99 mD | 00:12:41 | 8.86 mD |

In FIG. 4, the exemplary cross-plot illustrates a comparison of upscaled relative permeability computed using i) the upscaling method 100 (automated process with a convergence analysis); and ii) conventional upscaling (manual submission). The conventional upscaling computations are separated into converged [Man, Convg] and diverged [Man, Divrg]. The upscaled relative permeability results illustrated with the curve KRW [Auto] and KROW [Auto], respectively, were computed using the method 100. The KRW and KROW [Man, Divrg] computations, respectively, refer to the upscaled relative permeability submitted to the reservoir simulator sequentially by conventional methods and computed before convergence was attained thus, the solution is divergent. The KRW and KROW [Man, Convg], respectively, were submitted to the reservoir simulator sequentially by conventional methods and computed once convergence was attainted. In this example, the upscaled relative permeability computed by the upscaling method 100 achieves even greater accuracy over conventional upscaling because it models the coreflooding procedure while conventional upscaling is initiated from a saturated state that would not be achievable during a standard two fluid component flooding and only computes a pseudo-fractional fluid flow since the initial saturation is not a function of the previous steady-state fractional fluid flow step.

### System Description

The present disclosure may be implemented through a computer-executable program of instructions, such as program modules, generally referred to as software applications or application programs executed by a computer. The software may include, for example, routines, programs, objects, components, data structures, etc., that perform particular tasks or implement particular abstract data types. The software forms an interface to allow a computer to react according to a source of input. Nexus Desktop™, which is a commercial software application marketed by Landmark Graphics Corporation, may be used as an interface application to implement the present disclosure. The software may also cooperate with other code segments to initiate a variety of tasks in response to data received in conjunction with the source of the received data. Other code segments may provide optimization components including, but not limited to, neural networks, earth modeling, history-matching, optimization, visualization, data management, reservoir simulation and economics. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire, and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 5, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer-executable instructions, executed by the computing unit for implementing the present disclosure described herein and illustrated in FIGS. 1-4. The memory therefore, includes a relative permeability upscaling module, which enables steps 128-130 in FIG. 1B. The relative permeability upscaling module may integrate functionality from the remaining application programs illustrated in FIG. 5. In particular, Nexus Desktop™ may be used as an interface application to perform the remaining steps in FIGS. 1A-1B. In addition, an ASCII text file may be used to store the instructions and/or data input in step 101 for the reservoir simulator. Although Nexus Desktop™ may be used as an interface application, other interface applications may be used, instead, or the relative permeability upscaling module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to and/or presently being operated on by the processing unit. By way of example, and not limitation, the computing unit includes an operating system, application programs, other program modules, and program data.

The components shown in the memory may also be included in other removable/non-removable, volatile/nonvolatile computer storage media or they may be implemented in the computing unit through an application program interface (“API”) or cloud computing, which may reside on a separate computing unit connected through a computer system or network. For example only, a hard disk drive may read from or write to non-removable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, voice recognition or gesture recognition, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof

What is claimed:

1. A method for upscaling relative permeability using fractional flow in systems comprising disparate rock types, which comprises:
a) initializing a pressure buildup stage for an initialized numerical model by running a reservoir simulator for a time increment (i) corresponding to a predetermined pressure buildup time step used to run the reservoir simulator on the initialized numerical model; and ii) bounded by a maximum fluid flow rate;
b) initializing a fractional fluid flow stage for a last numerical model run by running the reservoir simulator for a time increment corresponding to a predetermined fractional fluid flow time step to produce an actual production rate based on an actual injection rate;
c) repeating step b) for each next fractional fluid flow stage;
d) computing an upscaled absolute permeability for a system comprising disparate rock types using a computer processor and a predetermined fractional fluid flow time step for an actual production rate and an actual injection rate that have converged to within a predetermined tolerance for the fractional fluid flow stage; and
e) computing an upscaled relative permeability for the system by dividing an upscaled effective permeability by the upscaled absolute permeability computed in step d).

2. The method of claim 1, further comprising:
f) running the reservoir simulator on the numerical model used in step a) for another predetermined pressure buildup time step; and
g) repeating step f) until the another predetermined pressure buildup time step is greater than a predetermined pressure buildup time control.

3. The method of claim 1, wherein the last numerical model run is from step a).

4. The method of claim 2, wherein the last numerical model run is from step g).

5. The method of claim 1, further comprising:
f) running the reservoir simulator on the last numerical model run for another predetermined fractional fluid flow time step; and
g) repeating step f) until the actual production rate and the actual injection rate have converged to within the predetermined tolerance.

6. The method of claim 1, wherein the numerical model is initialized using reservoir simulator data comprising porosity, absolute permeability, relative permeability, petrophysical cutoffs, maximum fluid flow rate, number of fractional fluid flow stages, the predetermined pressure buildup time control, and the predetermined tolerance for the actual production rate and the actual injection rate.

7. The method of claim 6, wherein the reservoir simulator data further comprises capillary pressure.

8. The method of claim 1, wherein the reservoir simulator data is derived from a combination of seismic and log petrophysical data retrieved from sensors.

9. A non-transitory program carrier device tangibly carrying computer executable instructions for upscaling relative permeability using fractional flow in systems comprising disparate rock types, the instructions being executable to implement:
a) initializing a pressure buildup stage for an initialized numerical model by running a reservoir simulator for a time increment (i) corresponding to a predetermined pressure buildup time step used to run the reservoir simulator on the initialized numerical model; and ii) bounded by a maximum fluid flow rate;
b) initializing a fractional fluid flow stage for a last numerical model run by running the reservoir simulator for a time increment corresponding to a predetermined fractional fluid flow time step to produce an actual production rate based on an actual injection rate;
c) repeating step b) for each next fractional fluid flow stage;
d) computing an upscaled absolute permeability for a system comprising disparate rock types using a predetermined fractional fluid flow time step for an actual production rate and an actual injection rate that have converged to within a predetermined tolerance for the fractional fluid flow stage; and
e) computing an upscaled relative permeability for the system by dividing an upscaled effective permeability by the upscaled absolute permeability computed in step d).

10. The program carrier device of claim 9, further comprising:
f) running the reservoir simulator on the numerical model used in step a) for another predetermined pressure buildup time step; and
g) repeating step f) until the another predetermined pressure buildup time step is greater than a predetermined pressure buildup time control.

11. The program carrier device of claim 9, wherein the last numerical model run is from step a).

12. The program carrier device of claim 10, wherein the last numerical model run is from step g).

13. The program carrier device of claim 9, further comprising:
f) running the reservoir simulator on the last numerical model run for another predetermined fractional fluid flow time step; and
g) repeating step f) until the actual production rate and the actual injection rate have converged to within the predetermined tolerance.

14. The program carrier device of claim 9, wherein the numerical model is initialized using reservoir simulator data comprising porosity, absolute permeability, relative permeability, petrophysical cutoffs, maximum fluid flow rate, number of fractional fluid flow stages, the predetermined pressure buildup time control, and the predetermined tolerance for the actual production rate and the actual injection rate.

15. The program carrier device of claim 14, wherein the reservoir simulator data further comprises capillary pressure.

16. The program carrier device of claim 9, wherein the reservoir simulator data is derived from a combination of seismic and log petrophysical data retrieved from sensors.

17. A non-transitory program carrier device tangibly carrying computer executable instructions for upscaling relative permeability using fractional flow in systems comprising disparate rock types, the instructions being executable to implement:
a) initializing a pressure buildup stage for an initialized numerical model by running a reservoir simulator for a time increment (i) corresponding to a predetermined pressure buildup time step used to run the reservoir simulator on the initialized numerical model; and ii) bounded by a maximum fluid flow rate;
b) initializing a fractional fluid flow stage for a last numerical model run by running the reservoir simulator for a time increment corresponding to a predetermined fractional fluid flow time step;
c) repeating step b) for each next fractional fluid flow stage;
d) computing an upscaled absolute permeability for a system comprising disparate rock types using a predetermined fractional fluid flow time step for an actual production rate and an actual injection rate that have converged to within a predetermined tolerance for the fractional fluid flow stage;
e) computing an upscaled relative permeability for the system by dividing an upscaled effective permeability by the upscaled absolute permeability computed in step d);
f) running the reservoir simulator on the numerical model used in step a) for another predetermined pressure buildup time step; and
g) repeating step f) until the another predetermined pressure buildup time step is greater than a predetermined pressure buildup time control.

18. The program carrier device of claim 17, wherein the last numerical model run is from step a).

19. The program carrier device of claim 18, wherein the last numerical model run is from step g).

20. The program carrier device of claim 17, further comprising:
f) running the reservoir simulator on the last numerical model run for another predetermined fractional fluid flow time step; and
g) repeating step f) until the actual production rate and the actual injection rate have converged to within the predetermined tolerance.
